(19) United States
(12) Patent Application Publication
(10) Pub. No.: US 2021/0034579 A1
(43) Pub. Date: Feb. 4, 2021

(54) SYSTEM AND METHOD FOR DEDUPLICATION OPTIMIZATION

(71) Applicant: EMC IP Holding Company, LLC, Hopkinton, MA (US)

(72) Inventors: IVAN BASOV, Brookline, MA (US); Sorin Faibish, Newton, MA (US); Istvan Gonczi, Berkley, MA (US); Philippe Armangau, Acton, MA (US)

(21) Appl. No.: 16/529,538

(22) Filed: Aug. 1, 2019

(51) Int. Cl. G06F 16/174; G06F 16/13; G06F 3/06; G06F 9/54

(52) U.S. Cl. CPC G06F 16/1752; G06F 16/137; G06F 9/54; G06F 3/0608; G06F 3/067; G06F 3/0641

(57) ABSTRACT

A method, computer program product, and computer system for identifying, at a block level of a file, a duplicate block of a plurality of blocks within the file. Granularity of a block size used for deduplication of the file at the block level may be adjusted. A type of deduplication may be adjusted for the file. Deduplication of the file at the block level within the file may be executed based upon, at least in part, the granularity of the block size used for deduplication of the file at the block level.

### BACKGROUND

Generally, the majority of flash array vendors may use smaller size IOs that may be written as a single IO, regardless if they are blocks of a larger object. Data reduction opportunities that apply to large files may therefore be missed and cannot be recovered, even by late binding, except perhaps for re-compressing the smaller chunks (e.g., KB's in size) using higher compression levels limited to the smaller blocks.

### BRIEF SUMMARY OF DISCLOSURE

In one example implementation, a method, performed by one or more computing devices, may include but is not limited to identifying, at a block level of a file, a duplicate block of a plurality of blocks within the file. Granularity of a block size used for deduplication of the file at the block level may be adjusted. A type of deduplication may be adjusted for the file. Deduplication of the file at the block level within the file may be executed based upon, at least in part, the granularity of the block size used for deduplication of the file at the block level.

One or more of the following example features may be included. Hashes of the plurality of blocks may be stored. The hashes of the plurality of blocks may be stored as part of file metadata of the file. The hashes of the plurality of blocks may be stored as part of the file metadata of the file as extended attributes sent to a block array to a NAS file system. The extended attributes may be sent to the block array to the NAS file system using an Application Programming Interface (API) call. The granularity may be adjusted on a file by file basis. Execution of the granularity may be based upon, at least in part, available resources.

In another example implementation, a computing system may include one or more processors and one or more memories configured to perform operations that may include but are not limited to identifying, at a block level of a file, a duplicate block of a plurality of blocks within the file. Granularity of a block size used for deduplication of the file at the block level may be adjusted. A type of deduplication may be adjusted for the file. Deduplication of the file at the block level within the file may be executed based upon, at least in part, the granularity of the block size used for deduplication of the file at the block level.

One or more of the following example features may be included. Hashes of the plurality of blocks may be stored. The hashes of the plurality of blocks may be stored as part of file metadata of the file. The hashes of the plurality of blocks may be stored as part of the file metadata of the file as extended attributes sent to a block array to a NAS file system. The extended attributes may be sent to the block array to the NAS file system using an Application Programming Interface (API) call. The granularity may be adjusted on a file by file basis. Execution of the granularity may be based upon, at least in part, available resources.

In another example implementation, a computer program product may reside on a computer readable storage medium having a plurality of instructions stored thereon which, when executed across one or more processors, may cause at least a portion of the one or more processors to perform operations that may include but are not limited to identifying, at a block level of a file, a duplicate block of a plurality of blocks within the file. Granularity of a block size used for deduplication of the file at the block level may be adjusted. A type of deduplication may be adjusted for the file. Deduplication of the file at the block level within the file may be executed based upon, at least in part, the granularity of the block size used for deduplication of the file at the block level.

One or more of the following example features may be included. Hashes of the plurality of blocks may be stored. The hashes of the plurality of blocks may be stored as part of file metadata of the file. The hashes of the plurality of blocks may be stored as part of the file metadata of the file as extended attributes sent to a block array to a NAS file system. The extended attributes may be sent to the block array to the NAS file system using an Application Programming Interface (API) call. The granularity may be adjusted on a file by file basis. Execution of the granularity may be based upon, at least in part, available resources.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a dedupe process coupled to an example distributed computing network according to one or more example implementations of the disclosure;

FIG. 2 is an example diagrammatic view of a storage system of FIG. 1 according to one or more example implementations of the disclosure;

FIG. 3 is an example diagrammatic view of a storage target of FIG. 1 according to one or more example implementations of the disclosure;

FIG. 4 is an example flowchart of a dedupe process according to one or more example implementations of the disclosure; and

FIG. 5 is an example diagrammatic view of a table structure of metadata stored by an array regarding characteristics of data blocks associated with different types of files according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

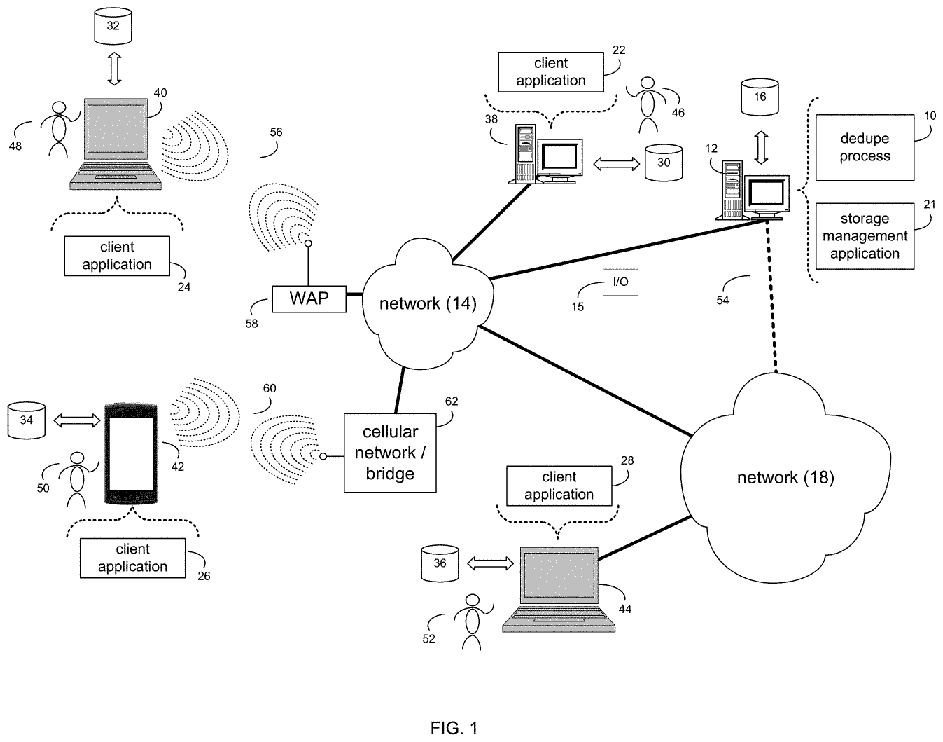

Referring now to the example implementation of FIG. 1, there is shown dedupe process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a dedupe process, such as dedupe process 10 of FIG. 1, may identify, at a block level of a file, a duplicate block of a plurality of blocks within the file. Granularity of a block size used for deduplication of the file at the block level may be adjusted. A type of deduplication may be adjusted for the file. Deduplication of the file at the block level within the file may be executed based upon, at least in part, the granularity of the block size used for deduplication of the file at the block level.

In some implementations, the instruction sets and subroutines of dedupe process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, dedupe process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a storage management application (e.g., storage management application 21), examples of which may include, but are not limited to, e.g., a storage system application, a cloud computing application, a data synchronization application, a data migration application, a garbage collection application, or other application that allows for the implementation and/or management of data in a clustered (or non-clustered) environment (or the like). In some implementations, dedupe process 10 and/or storage management application 21 may be accessed via one or more of client applications 22, 24, 26, 28. In some implementations, dedupe process 10 may be a standalone application, or may be an applet/application/script/extension that may interact with and/or be executed within storage management application 21, a component of storage management application 21, and/or one or more of client applications 22, 24, 26, 28. In some implementations, storage management application 21 may be a standalone application, or may be an applet/application/script/extension that may interact with and/or be executed within dedupe process 10, a component of dedupe process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of dedupe process 10 and/or storage management application 21. Examples of client applications 22, 24, 26, 28 may include, but are not limited to, e.g., a storage system application, a cloud computing application, a data synchronization application, a data migration application, a garbage collection application, or other application that allows for the implementation and/or management of data in a clustered (or non-clustered) environment (or the like), a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of dedupe process 10 (and vice versa). Accordingly, in some implementations, dedupe process 10 may be a purely server-side application, a purely client-side application, or a hybrid server-side/client-side application that is cooperatively executed by one or more of client applications 22, 24, 26, 28 and/or dedupe process 10.

In some implementations, one or more of client applications 22, 24, 26, 28 may be configured to effectuate some or all of the functionality of storage management application 21 (and vice versa). Accordingly, in some implementations, storage management application 21 may be a purely server-side application, a purely client-side application, or a hybrid server-side/client-side application that is cooperatively executed by one or more of client applications 22, 24, 26, 28 and/or storage management application 21. As one or more of client applications 22, 24, 26, 28, dedupe process 10, and storage management application 21, taken singly or in any combination, may effectuate some or all of the same functionality, any description of effectuating such functionality via one or more of client applications 22, 24, 26, 28, dedupe process 10, storage management application 21, or combination thereof, and any described interaction(s) between one or more of client applications 22, 24, 26, 28, dedupe process 10, storage management application 21, or combination thereof to effectuate such functionality, should be taken as an example only and not to limit the scope of the disclosure.

In some implementations, one or more of users 46, 48, 50, 52 may access computer 12 and dedupe process 10 (e.g., using one or more of client electronic devices 38, 40, 42, 44) directly through network 14 or through secondary network 18. Further, computer 12 may be connected to network 14 through secondary network 18, as illustrated with phantom link line 54. Dedupe process 10 may include one or more user interfaces, such as browsers and textual or graphical user interfaces, through which users 46, 48, 50, 52 may access dedupe process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12. Examples of I/O request 15 may include but are not limited to, data write requests (e.g., a request that content be written to computer 12) and data read requests (e.g., a request that content be read from computer 12).

Data Storage System:

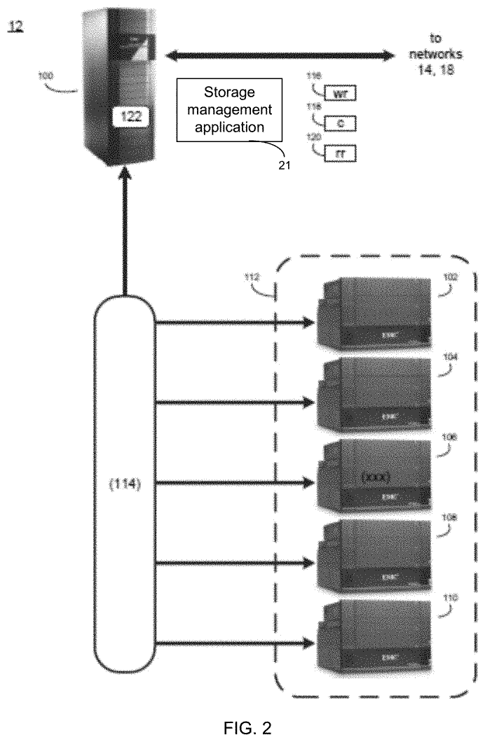

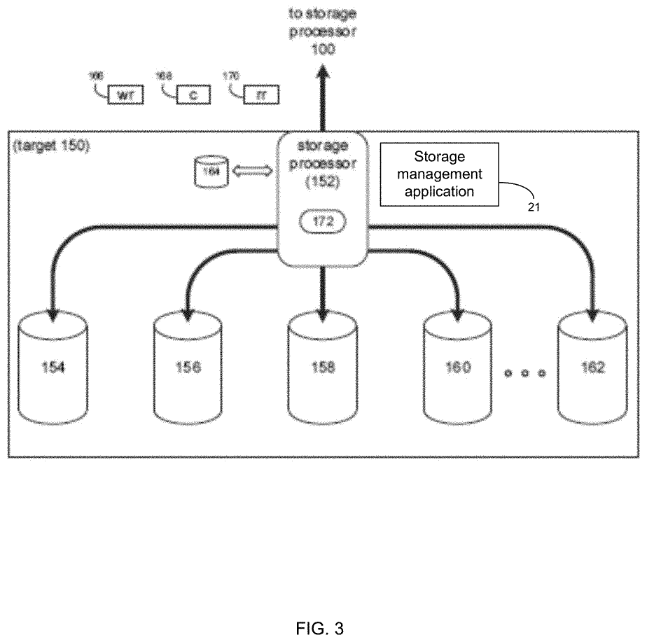

Referring also to the example implementation of FIGS. 2-3 (e.g., where computer 12 may be configured as a data storage system), computer 12 may include storage processor 100 and a plurality of storage targets (e.g., storage targets 102, 104, 106, 108, 110). In some implementations, storage targets 102, 104, 106, 108, 110 may include any of the above-noted storage devices. In some implementations, storage targets 102, 104, 106, 108, 110 may be configured to provide various levels of performance and/or high availability. For example, storage targets 102, 104, 106, 108, 110 may be configured to form a non-fully-duplicative fault-tolerant data storage system (such as a non-fully-duplicative RAID data storage system), examples of which may include but are not limited to: RAID 3 arrays, RAID 4 arrays, RAID 5 arrays, and/or RAID 6 arrays. It will be appreciated that various other types of RAID arrays may be used without departing from the scope of the present disclosure.

While in this particular example, computer 12 is shown to include five storage targets (e.g., storage targets 102, 104, 106, 108, 110), this is for example purposes only and is not intended limit the present disclosure. For instance, the actual number of storage targets may be increased or decreased depending upon, e.g., the level of redundancy/performance/capacity required.

Further, the storage targets (e.g., storage targets 102, 104, 106, 108, 110) included with computer 12 may be configured to form a plurality of discrete storage arrays. For instance, and assuming for example purposes only that computer 12 includes, e.g., ten discrete storage targets, a first five targets (of the ten storage targets) may be configured to form a first RAID array and a second five targets (of the ten storage targets) may be configured to form a second RAID array.

In some implementations, one or more of storage targets 102, 104, 106, 108, 110 may be configured to store coded data (e.g., via storage management process 21), wherein such coded data may allow for the regeneration of data lost/corrupted on one or more of storage targets 102, 104, 106, 108, 110. Examples of such coded data may include but is not limited to parity data and Reed-Solomon data. Such coded data may be distributed across all of storage targets 102, 104, 106, 108, 110 or may be stored within a specific storage target.

Examples of storage targets 102, 104, 106, 108, 110 may include one or more data arrays, wherein a combination of storage targets 102, 104, 106, 108, 110 (and any processing/control systems associated with storage management application 21) may form data array 112.

The manner in which computer 12 is implemented may vary depending upon e.g., the level of redundancy/performance/capacity required. For example, computer 12 may be configured as a SAN (i.e., a Storage Area Network), in which storage processor 100 may be, e.g., a dedicated computing system and each of storage targets 102, 104, 106, 108, 110 may be a RAID device. An example of storage processor 100 may include but is not limited to a VPLEX™, VNX™, or Unity™ system offered by Dell EMC™ of Hopkinton, Mass.

In the example where computer 12 is configured as a SAN, the various components of computer 12 (e.g., storage processor 100, and storage targets 102, 104, 106, 108, 110) may be coupled using network infrastructure 114, examples of which may include but are not limited to an Ethernet (e.g., Layer 2 or Layer 3) network, a fiber channel network, an InfiniBand network, or any other circuit switched/packet switched network.

As discussed above, various I/O requests (e.g., I/O request 15) may be generated. For example, these I/O requests may be sent from, e.g., client applications 22, 24, 26, 28 to, e.g., computer 12. Additionally/alternatively (e.g., when storage processor 100 is configured as an application server or otherwise), these I/O requests may be internally generated within storage processor 100 (e.g., via storage management process 21). Examples of I/O request 15 may include but are not limited to data write request 116 (e.g., a request that content 118 be written to computer 12) and data read request 120 (e.g., a request that content 118 be read from computer 12).

In some implementations, during operation of storage processor 100, content 118 to be written to computer 12 may be received and/or processed by storage processor 100 (e.g., via storage management process 21). Additionally/alternatively (e.g., when storage processor 100 is configured as an application server or otherwise), content 118 to be written to computer 12 may be internally generated by storage processor 100 (e.g., via storage management process 21).

As discussed above, the instruction sets and subroutines of storage management application 21, which may be stored on storage device 16 included within computer 12, may be executed by one or more processors and one or more memory architectures included with computer 12. Accordingly, in addition to being executed on storage processor 100, some or all of the instruction sets and subroutines of storage management application 21 (and/or dedupe process 10) may be executed by one or more processors and one or more memory architectures included with data array 112.

In some implementations, storage processor 100 may include front end cache memory system 122. Examples of front end cache memory system 122 may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

In some implementations, storage processor 100 may initially store content 118 within front end cache memory system 122. Depending upon the manner in which front end cache memory system 122 is configured, storage processor 100 (e.g., via storage management process 21) may immediately write content 118 to data array 112 (e.g., if front end cache memory system 122 is configured as a write-through cache) or may subsequently write content 118 to data array 112 (e.g., if front end cache memory system 122 is configured as a write-back cache).

In some implementations, one or more of storage targets 102, 104, 106, 108, 110 may include a backend cache memory system. Examples of the backend cache memory system may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

Storage Targets:

As discussed above, one or more of storage targets 102, 104, 106, 108, 110 may be a RAID device. For instance, and referring also to FIG. 3, there is shown example target 150, wherein target 150 may be one example implementation of a RAID implementation of, e.g., storage target 102, storage target 104, storage target 106, storage target 108, and/or storage target 110. An example of target 150 may include but is not limited to a VPLEX™ VNX™ or Unity™ system offered by Dell EMC™ of Hopkinton, Mass. Examples of storage devices 154, 156, 158, 160, 162 may include one or more electro-mechanical hard disk drives, one or more solid-state/flash devices, and/or any of the above-noted storage devices. It will be appreciated that while the term “disk” or “drive” may be used throughout, these may refer to and be used interchangeably with any types of appropriate storage devices as the context and functionality of the storage device permits.

In some implementations, target 150 may include storage processor 152 and a plurality of storage devices (e.g., storage devices 154, 156, 158, 160, 162). Storage devices 154, 156, 158, 160, 162 may be configured to provide various levels of performance and/or high availability (e.g., via storage management process 21). For example, one or more of storage devices 154, 156, 158, 160, 162 (or any of the above-noted storage devices) may be configured as a RAID 0 array, in which data is striped across storage devices. By striping data across a plurality of storage devices, improved performance may be realized. However, RAID 0 arrays may not provide a level of high availability. Accordingly, one or more of storage devices 154, 156, 158, 160, 162 (or any of the above-noted storage devices) may be configured as a RAID 1 array, in which data is mirrored between storage devices. By mirroring data between storage devices, a level of high availability may be achieved as multiple copies of the data may be stored within storage devices 154, 156, 158, 160, 162.

While storage devices 154, 156, 158, 160, 162 are discussed above as being configured in a RAID 0 or RAID 1 array, this is for example purposes only and not intended to limit the present disclosure, as other configurations are possible. For example, storage devices 154, 156, 158, 160, 162 may be configured as a RAID 3, RAID 4, RAID 5 or RAID 6 array.

While in this particular example, target 150 is shown to include five storage devices (e.g., storage devices 154, 156, 158, 160, 162), this is for example purposes only and not intended to limit the present disclosure. For instance, the actual number of storage devices may be increased or decreased depending upon, e.g., the level of redundancy/performance/capacity required.

In some implementations, one or more of storage devices 154, 156, 158, 160, 162 may be configured to store (e.g., via storage management process 21) coded data, wherein such coded data may allow for the regeneration of data lost/corrupted on one or more of storage devices 154, 156, 158, 160, 162. Examples of such coded data may include but are not limited to parity data and Reed-Solomon data. Such coded data may be distributed across all of storage devices 154, 156, 158, 160, 162 or may be stored within a specific storage device.

The manner in which target 150 is implemented may vary depending upon e.g., the level of redundancy/performance/capacity required. For example, target 150 may be a RAID device in which storage processor 152 is a RAID controller card and storage devices 154, 156, 158, 160, 162 are individual “hot-swappable” hard disk drives. Another example of target 150 may be a RAID system, examples of which may include but are not limited to an NAS (i.e., Network Attached Storage) device or a SAN (i.e., Storage Area Network).

In some implementations, storage target 150 may execute all or a portion of storage management application 21. The instruction sets and subroutines of storage management application 21, which may be stored on a storage device (e.g., storage device 164) coupled to storage processor 152, may be executed by one or more processors and one or more memory architectures included with storage processor 152. Storage device 164 may include but is not limited to any of the above-noted storage devices.

As discussed above, computer 12 may be configured as a SAN, wherein storage processor 100 may be a dedicated computing system and each of storage targets 102, 104, 106, 108, 110 may be a RAID device. Accordingly, when storage processor 100 processes data requests 116, 120, storage processor 100 (e.g., via storage management process 21) may provide the appropriate requests/content (e.g., write request 166, content 168 and read request 170) to, e.g., storage target 150 (which is representative of storage targets 102, 104, 106, 108 and/or 110).

In some implementations, during operation of storage processor 152, content 168 to be written to target 150 may be processed by storage processor 152 (e.g., via storage management process 21). Storage processor 152 may include cache memory system 172. Examples of cache memory system 172 may include but are not limited to a volatile, solid-state, cache memory system (e.g., a dynamic RAM cache memory system) and/or a non-volatile, solid-state, cache memory system (e.g., a flash-based, cache memory system). During operation of storage processor 152, content 168 to be written to target 150 may be received by storage processor 152 (e.g., via storage management process 21) and initially stored (e.g., via storage management process 21) within front end cache memory system 172.

As noted above, generally, the majority of flash array vendors may use smaller size IOs that may be written as a single IO, regardless if they are blocks of a larger object. Data reduction opportunities that apply to large files may therefore be missed and cannot be recovered, even by late binding, except perhaps for re-compressing the smaller chunks (e.g., KB's in size) using higher compression levels limited to the smaller blocks. Without knowledge from the upper file server layer, it may not be possible to improve data reduction and compression that can be achieved for large files.

It may be shown that the compression efficiency may be highest when entire files are compressed, rather than small chunks and for blocks of, e.g., 128 KB by more than, e.g., 5% according to the data compressibility and the compression level, without accounting for duplicated blocks inside the objects that are missed. Moreover, when using larger blocks, the data reduction achieved by compression only is lower than when smaller chunks are deduped inside the larger object, resulting in higher “equivalent” compression and dedupe combination. Just applying compression to very large files and objects does not necessarily achieve maximum data reduction. However, if, e.g., 4 kB blocks are also deduplicated inside the large file, the server may be sending the metadata to the block device for entire files, better data reduction may be achieved than if just the file is compressed. In addition to better data reduction, the digest cache used may be reduced as well as reducing the metadata compared to the case when there is block by block deduplication.

Therefore, as will be discussed below, the present disclosure may enable the user to control the granularity of the deduplication in storage arrays. Adding user control of the deduplication methods and parameters may be achieved by using the extended attributes functionality available to the file server layer. Even if the user can change the block granularity for the block server it may still be limited by the size of the blocks of the array, either fixed or variable, but as there is no information of groups of blocks aggregated together, as it is for files, the efficiency of such a solution may be limited in deduplication. The same idea may apply to objects in an object store. In the block case, the best the user added information can do may be to select between fixed block, variable block or anchor based deduplication, but there may not be any Quality of Service (QoS) available. The in-file data deduplication may be done also as a background operation for improved IO Per Second (IOPS) and reduced latency.

The Dedupe Process:

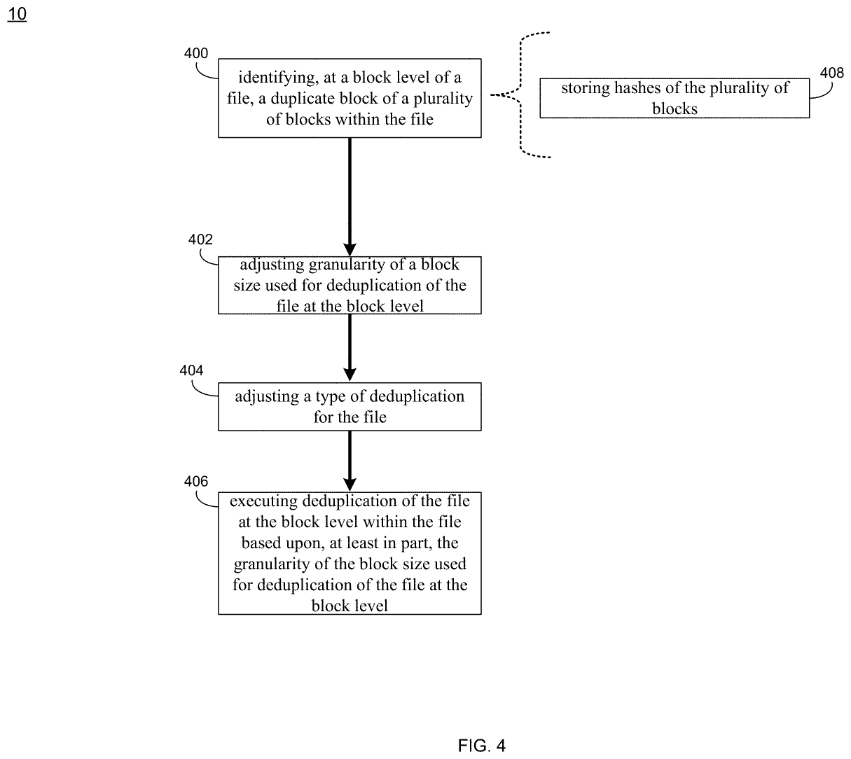

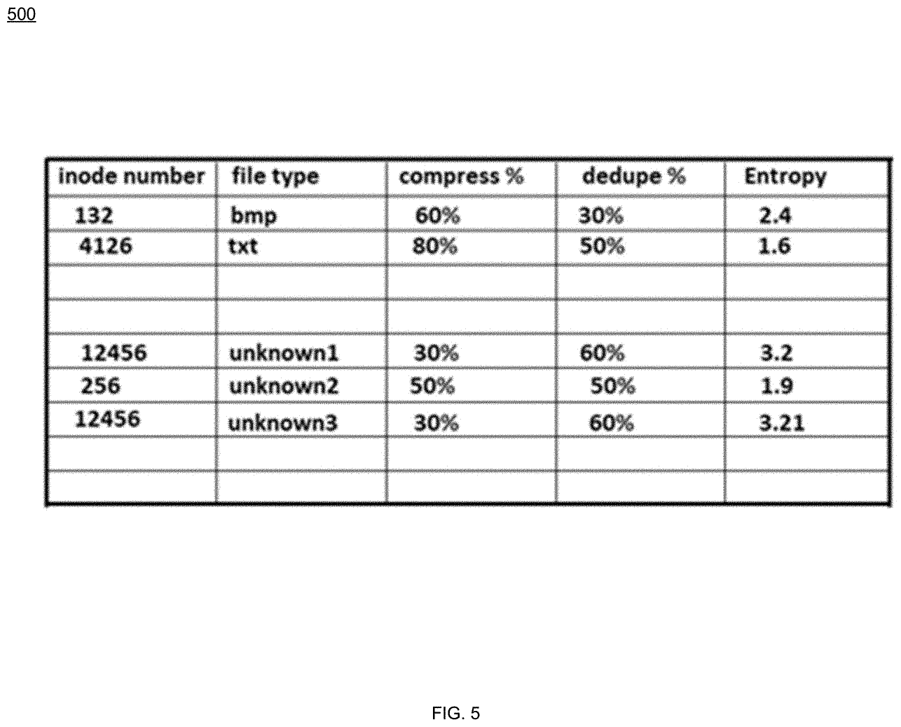

As discussed above and referring also at least to the example implementations of FIGS. 4-5, dedupe process 10 may identify 400, at a block level of a file, a duplicate block of a plurality of blocks within the file. Dedupe process 10 may adjust 402 granularity of a block size used for deduplication of the file at the block level. Dedupe process 10 may 404 adjust a type of deduplication for the file. Dedupe process 10 may execute 406 deduplication of the file at the block level within the file based upon, at least in part, the granularity of the block size used for deduplication of the file at the block level.

In some implementations, dedupe process 10 may identify 400, at a block level of a file, a duplicate block of a plurality of blocks within the file. For example, as will be discussed below, hashes at the block level of a file may be used to identify 400 duplicate blocks of a file at the block level. Additional optimizations may be applied in order to improve the deduplication of blocks inside the, e.g., 16 MB segments and for the entire file by using sector level variable deduplication across all the 16 MB segments of a large file. The reduplication operation may be initiated by the file server (e.g., via dedupe process 10) when the IO load of accessing the file server is low. The file server may have access to the deduplication percent achieved during the inline operation with fixed block granularity of, e.g., 4 KB-32 KB inside a very large file and it may send a rededupe command to the array requesting a new percent of deduplication based on application data or by user defined granularity of the minimum block size used for variable dedupe of a large file. The idea is that when a large file is deduped inside the co-locality of the smaller blocks, this may be good enough for variable dedupe with different granularities according to the available computer resources. Potentially, the file server may go to the path of using advanced deduplication methods using, e.g., Broder and Rabin methods and anchors done in the background when the IO load on the server is low enough.

As noted above, hashes at the block level of a file may be used to identify 400 duplicate blocks of a file at the block level. For instance, in some implementations, dedupe process 10 may store 408 hashes of the plurality of blocks (e.g., stored as part of file metadata of the file as extended attributes sent to a block array to a NAS file system using an Application Programming Interface (API) call. For example, as will be discussed below, it may be advantageous to run the deduplication of sectors or blocks inside the large files and store the hashes of the blocks as part of the file metadata to allow faster deduplication of the blocks inside the large files. This may reduce the size of digest memory that is used for block deduplication by storing in the file metadata all the hashes of the blocks included in the file as extended attributes sent to the block array to the (e.g., NAS) file system using the API noted below.

For example, the API may allow the file layer to send special metadata that the block layer may use to build a table that may allow it to identify different types of files and their data reduction characteristics. An example table structure 500 of the metadata stored by the array regarding characteristics of data blocks associated with different types of files is shown for example purposes only in the example implementation of FIG. 5. Additional information may include the digital entropy of the file calculated by a block compression engine and used to detect unknown files characteristics “learned” by the block layer. In some implementations, the file layer may (e.g., via dedupe process 10) mark all the blocks written to the array with the inode number and offset in the file so that the block layer can aggregate all the file's blocks in the order they are streamed to the block device and reconstruct the file in the backend cache before applying compression and dedupe. An alternative solution may be for the file layer to write large chunks of the file to the backend and the block layer may detect the sequence of blocks in a single IO. As an extension the API could hint to the array that a sequence of N blocks will be written to the backend as a single chunk of data; the API may send the start block and run length call before the IO is written. The storage array (e.g., via dedupe process 10) may organize the entire sequence as a single chunk in the cache and may perform data reduction as a single unit. There may also be a threshold defined by the API regarding which files are not large enough to justify waiting for all the blocks to be written to the array or the array compression engine of dedupe process 10 may decide to activate file level or block level data reduction.

In some implementations, the above table may not include the file size or object size because in file servers the end of the file is not always used by NAS protocols. As a result, it may not be feasible to know the file sizes unless they are small in size and can be written as a single IO. In order to, overcome this problem of lack of file size to be compressed as a single unit, dedupe process 10 may use large chunks of an object as their unit of compression. As an example with the largest compression unit being 16 MB, if the same unit is used for the file size only 16 MB chunks may be compressed at a time. As an alternative solution, dedupe process 10 may define the “file size” by the largest chunk for which the compression is more than 99%. A standard data set used for tuning the compression of 16 MB may be large enough for any other data types to achieve 99% compression for large files compressed using, e.g., Linux LZ7 algorithm. So, the 16 MB may be used as a maximum file size to be written in one IO, but a minimum size threshold may be used that will help decide between large and small files, for example 64 KB, such that for files smaller than 64 KB the normal data reduction may be used by the block devices with compression lower than 90% for example. Files larger than the example size of 64 KB may be treated as large files and will use file level compression engine while for smaller files block level compression may be used at block granularity.

In some implementations, if the file has known compression and dedupe characteristics, then it may be assumed for example purposes only that all the 16 MB chunks may have similar statistics for a given file type and there will not be an update to the array table in FIG. 5 with achieved compression values of the compression percent, even if it is not equal to the values in the table. But in the cases when there is no available data about the file type, dedupe process 10 may update the compression and dedupe percent after the 16 MB segment is flushed to the disk. If the file type is unknown but a segment belongs to the same large file, the array (e.g., via dedupe process 10) may update the compression and dedupe percent for each 16 MB as a different file and next compressed segment written may be added to the unknown type of file as a new type. For example, in FIG. 5 there are 3 unknown type segments; unknown1, unknown2 and unknown3. When a new unknown type segment is written, dedupe process 10 may associate it to the unknown type that matches its compression percent, dedupe percent and entropy, dedupe process 10 may add that segment as an aggregate of all the 16 MB segments of a file type unknown1 and all the new segments may be added to the type unknown1 if the 3 parameters match. This is a learning process that may be done using a machine learning technology and may allow the block layer to update the file layer using the communication protocol, that the file inode is of a type unknown1 defined by the reduction characteristics and the file layer may group all the files without an extension to same directory and allocate a new attribute with the name unknown1 for example.

In some implementations, dedupe process 10 may adjust 402 (e.g., on a file by file basis) granularity of a block size used for deduplication of the file at the block level, and in some implementations, dedupe process 10 may 404 adjust a type of deduplication for the file. For example, one way to communicate to the file layer is to use the above-noted extended attributes using, e.g., REST API calls to add the data reduction parameters as new extended attributes. After all the segments of a file are compressed and deduped, the above-noted table in the block array may have all the information needed to update the file system layer extended attributes such that next time when a file is written to the array it may communicate the reduction parameters attributes, e.g., ILC|ILD|ENT. This may allow the file system layer to group all the files with same attributes in a single directory and potentially add an extension name specific for these types of files, perhaps the files generated by a known application will have a new extension internal to the NAS server. This may allow the server (e.g., via dedupe process 10) to control the granularity of the variable block deduplication assessed by users on a file by file basis so the user may decide the granularity of the deduplication as well as type of deduplication (e.g., fixed size or variable size for each file).

In some implementations, dedupe process 10 may execute 406 deduplication of the file at the block level within the file based upon, at least in part, the granularity of the block size used for deduplication of the file at the block level, where in some implementations, execution of the granularity may be based upon, at least in part, available resources. For instance, all the above-noted information may be added in the table of FIG. 5 defined by the user via extended attributes and allowing the array to decide when to perform the finer granularity deduplication according to available computer resources. For instance, the higher the granularity, the more extensive computations may be needed when available. As a result, the block server (e.g., via dedupe process 10) may prioritize when to rededupe each of the files requested by the file server matching the available resources at the time of the request. This may enable the user to add quality of service (QoS) (defined in the file layer) regarding both IO and latency as well as data reduction applied.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying, at a block level of a file, a duplicate block of a plurality of blocks within the file;
adjusting granularity of a block size used for deduplication of the file at the block level;
adjusting a type of deduplication for the file; and
executing deduplication of the file at the block level within the file based upon, at least in part, the granularity of the block size used for deduplication of the file at the block level.

2. The computer-implemented method of claim 1 further comprising storing hashes of the plurality of blocks.

3. The computer-implemented method of claim 2 wherein the hashes of the plurality of blocks are stored as part of file metadata of the file.

4. The computer-implemented method of claim 3 wherein the hashes of the plurality of blocks are stored as part of the file metadata of the file as extended attributes sent to a block array to a NAS file system.

5. The computer-implemented method of claim 4 wherein the extended attributes are sent to the block array to the NAS file system using an Application Programming Interface (API) call.

6. The computer-implemented method of claim 1 wherein the granularity is adjusted on a file by file basis.

7. The computer-implemented method of claim 6 wherein execution of the granularity is based upon, at least in part, available resources.

8. A computer program product residing on a computer readable storage medium having a plurality of instructions stored thereon which, when executed across one or more processors, causes at least a portion of the one or more processors to perform operations comprising:
identifying, at a block level of a file, a duplicate block of a plurality of blocks within the file;
adjusting granularity of a block size used for deduplication of the file at the block level;
adjusting a type of deduplication for the file; and
executing deduplication of the file at the block level within the file based upon, at least in part, the granularity of the block size used for deduplication of the file at the block level.

9. The computer program product of claim 8 wherein the operations further comprise storing hashes of the plurality of blocks.

10. The computer program product of claim 9 wherein the hashes of the plurality of blocks are stored as part of file metadata of the file.

11. The computer program product of claim 10 wherein the hashes of the plurality of blocks are stored as part of the file metadata of the file as extended attributes sent to a block array to a NAS file system.

12. The computer program product of claim 11 wherein the extended attributes are sent to the block array to the NAS file system using an Application Programming Interface (API) call.

13. The computer program product of claim 8 wherein the granularity is adjusted on a file by file basis.

14. The computer program product of claim 13 wherein execution of the granularity is based upon, at least in part, available resources.

15. A computing system including one or more processors and one or more memories configured to perform operations comprising:
identifying, at a block level of a file, a duplicate block of a plurality of blocks within the file;
adjusting granularity of a block size used for deduplication of the file at the block level;
adjusting a type of deduplication for the file; and
executing deduplication of the file at the block level within the file based upon, at least in part, the granularity of the block size used for deduplication of the file at the block level.

16. The computing system of claim 15 wherein the operations further comprise storing hashes of the plurality of blocks.

17. The computing system of claim 16 wherein the hashes of the plurality of blocks are stored as part of file metadata of the file.

18. The computing system of claim 17 wherein the hashes of the plurality of blocks are stored as part of the file metadata of the file as extended attributes sent to a block array to a NAS file system.

19. The computing system of claim 18 wherein the extended attributes are sent to the block array to the NAS file system using an Application Programming Interface (API) call.

20. The computing system of claim 15 wherein the granularity is adjusted on a file by file basis and based upon, at least in part, available resources.
